(19) United States
(12) Patent Application Publication
(10) Pub. No.: US 2015/0251849 A1
(43) Pub. Date: Sep. 10, 2015

(54) RECEPTACLE WITH BAG LINER DISPENSER

(71) Applicant: Simplehuman, LLC, Torrance, CA (US)

(72) Inventors: Frank Yang, Rancho Palos Verdes, CA (US); Di-Fong Chang, Torrance, CA (US); Myk Wayne Lum, Irvine, CA (US); Adam C. Wade, Rancho Santa Margarita, CA (US); Helen Miller, Diamond Bar, CA (US)

(21) Appl. No.: 14/639,049

(22) Filed: Mar. 4, 2015

Related U.S. Application Data
(60) Provisional application No. 61/949,868, filed on Mar. 7, 2014.

(51) Int. Cl. B65F 1/06; B65F 1/16

(52) U.S. Cl. CPC B65F 1/062; B65F 1/16

(57) ABSTRACT

A receptacle assembly including a body portion having a front wall, a rear wall, and lateral sidewalls. The receptacle assembly can also include a bag liner dispenser disposed on an exterior surface of the rear wall, such that an interior surface of the rear wall remains generally planar. The bag liner dispenser can extend around a periphery of an opening that can provide access from the bag liner dispenser to an interior space of the body portion.

### RELATED APPLICATION

This application claims the priority benefit of U.S. Provisional Patent Application No. 61/949,868, filed on Mar. 7, 2014 and entitled “Receptacle with Bag Liner Dispenser,” the entire contents of which are hereby incorporated by reference herein and made part of this specification.

### BACKGROUND

1. Field

This disclosure relates generally to receptacle assemblies, and particularly in some embodiments to trash can assemblies with bag liners.

2. Description of the Related Art

Receptacles for holding waste (e.g., trash, recycling, compost, etc.) often employ disposable bag liners for containing the waste, for easily removing waste from the receptacle, and for preventing the waste from contaminating the receptacle. These receptacles have been improved over the years to make them more user-friendly, sanitary, and hygienic. For example, some trash cans include an interior metal or plastic container that can be configured to hold the waste and that fits within the receptacle. This container can accept a bag liner and can be removed and washed.

### SUMMARY

In conventional receptacles, the bag liners are not easily accessible. For example, the bag liners may be stored in a location spaced away from the receptacle, such as in a closet or under a sink. This can make it inconvenient to access a replacement liner and/or can increase the chance of a user forgetting to insert a replacement liner in the receptacle. As a result, the receptacle may be left without a bag liner for an extended period of time. During that time, waste may be thrown directly into the receptacle, thus contaminating the receptacle.

Certain aspects of the disclosure are directed toward a receptacle assembly including a body portion having a front wall, a rear wall, and lateral sidewalls. The receptacle assembly can also include a bag liner dispenser disposed at least partially on an exterior surface of the rear wall. In some embodiments, an interior surface of the rear wall remains generally planar. The bag liner dispenser can be positioned at or near an opening in the rear wall, or can extend generally around a periphery of an opening in the rear wall, that can provide access from the bag liner dispenser to an interior space of the body portion. The bag dispenser can hold a quantity of bag liners and provide ready access to the bag liners (e.g., to facilitate replacement of a used liner).

In certain aspects, the bag liner dispenser can be positioned closer to an upper edge of the body portion than a lower edge of the body portion. An upper edge of the bag liner dispenser can be displaced from the upper edge of the body portion and a lower edge of the bag liner dispenser can be displaced from the lower edge of the body portion.

In certain aspects, the opening can be generally flush with the rear wall and displaced from an upper edge of the body portion. The opening can be generally oblong, such that a length of the opening is greater than a height of the opening.

In certain aspects, the receptacle assembly can include a trim member extending at least partially around the upper edge of the body portion. A thickness of the bag liner dispenser can be less than or equal to about a thickness of a rear portion of the trim member, such that the bag liner dispenser does not extend in a rearward direction beyond a rear edge of the trim member.

In certain aspects, the receptacle assembly can include a generally rigid inner body portion (e.g., an inner waste container or an interior container) disposed within the interior space of the body portion. The inner body portion can have an opening that can be configured to provide access from the bag liner dispenser on the outside of the receptacle to an interior space of the inner body portion.

Certain aspects of the disclosure are directed toward a method of manufacturing a receptacle assembly. The method can include forming an opening on a rear wall of a body portion, and positioning a bag liner dispenser along an exterior surface of the rear wall, at or near a region with an opening, and/or extending around a periphery of the opening, or at least extending around a portion of the periphery of the opening, such that the opening provides access from the bag liner dispenser to an interior space of the body portion. The bag liner dispenser can be disposed exterior to the rear wall so that an interior surface of the rear wall remains generally planar.

In certain aspects, the method can include disposing the bag liner dispenser closer to an upper end of the body portion than a lower end of the body portion.

In certain aspects, the opening can be generally flush with the rear wall and displaced from an upper edge of the rear wall. Further, the opening can be generally oblong, such that a length of the opening is greater than a height of the opening.

In certain aspects, the method can include disposing a trim member at least partially around an upper edge of the body portion. A thickness of the bag liner dispenser can be less than or about equal to a thickness of a rear portion of the trim member, such that the bag liner dispenser does not extend in a rearward direction beyond a rear edge of the trim member.

In certain aspects, a method of using the receptacle can include inserting an inner body portion (e.g., an interior container) into the interior space of the body portion. The inner body portion can have an opening that provides access from the bag liner dispenser to an interior space of the inner body portion.

Certain aspects of the disclosure are directed toward a method of inserting a liner into a receptacle assembly having one or more of the features described herein. The method can include inserting a plurality of bag liners into a bag liner dispenser disposed on an exterior surface of a rear wall of the receptacle assembly. The bag liner dispenser can be positioned in a region at or near, or can extend around a periphery of, an opening disposed on the rear wall of the receptacle. The method can also include pulling a first bag of the plurality of bags through an opening disposed on the rear wall of the body portion into an interior of the receptacle.

Any feature, structure, or step disclosed herein can be replaced with or combined with any other feature, structure, or step disclosed herein, or omitted. Further, for purposes of summarizing the disclosure, certain aspects, advantages, and features of the inventions have been described herein. It is to be understood that not necessarily any or all such advantages are achieved in accordance with any particular embodiment of the inventions disclosed herein. No individual aspects of this disclosure are essential or indispensable.

### BRIEF DESCRIPTION OF THE DRAWINGS

Various embodiments are depicted in the accompanying drawings for illustrative purposes, and should in no way be interpreted as limiting the scope of the embodiments. Furthermore, various features of different disclosed embodiments can be combined to form additional embodiments, which are part of this disclosure.

FIG. 1A illustrates a rear perspective view of an example of a receptacle assembly having a bag liner dispenser.

FIG. 1B illustrates an enlarged, rear perspective view of the receptacle assembly shown in FIG. 1A with a lid portion and a rear cover of the bag liner dispenser not shown for purposes of presentation.

FIG. 1C illustrates an enlarged, front perspective view of the receptacle assembly shown in FIG. 1A with a lid portion not shown for purposes of presentation.

FIG. 2 illustrates a rear perspective view of another example of a receptacle assembly having a bag liner dispenser.

FIG. 3A illustrates a rear perspective view of an interior container having a bag liner dispenser.

FIG. 3B illustrates a front perspective view of the interior container shown in FIG. 3A.

FIG. 4 illustrates a rear perspective view of another interior container having a bag liner dispenser with a biasing element.

FIG. 5 illustrates a front perspective view of another example of a receptacle assembly with a lid portion not shown for presentation purposes.

FIG. 6 illustrates a cross-section of an example of a bag liner dispenser with a package of bag liners disposed within the bag liner dispenser.

FIG. 7A illustrates a cross-section of another bag liner dispenser having a biasing member and a package of bag liners disposed within the bag liner dispenser.

FIG. 7B illustrates a cross-section of another example of a bag liner dispenser having a biasing member.

FIG. 7C illustrates a front perspective view of the biasing member shown in FIG. 7B.

### DETAILED DESCRIPTION

Various bag liner dispensers are described below to illustrate various examples that may be employed to achieve one or more desired improvements. These examples are only illustrative and not intended in any way to restrict the general inventions presented and the various aspects and features of these inventions. Furthermore, the phraseology and terminology used herein is for the purpose of description and should not be regarded as limiting. No features, structure, or step disclosed herein is essential or indispensable. All sizes and proportions illustrated in the accompanying figures form part of this specification and are intended to be utilized as examples and to provide support for any claims that specifically refer to such illustrated sizes or proportions, but should not be considered as limiting the scope of this specification.

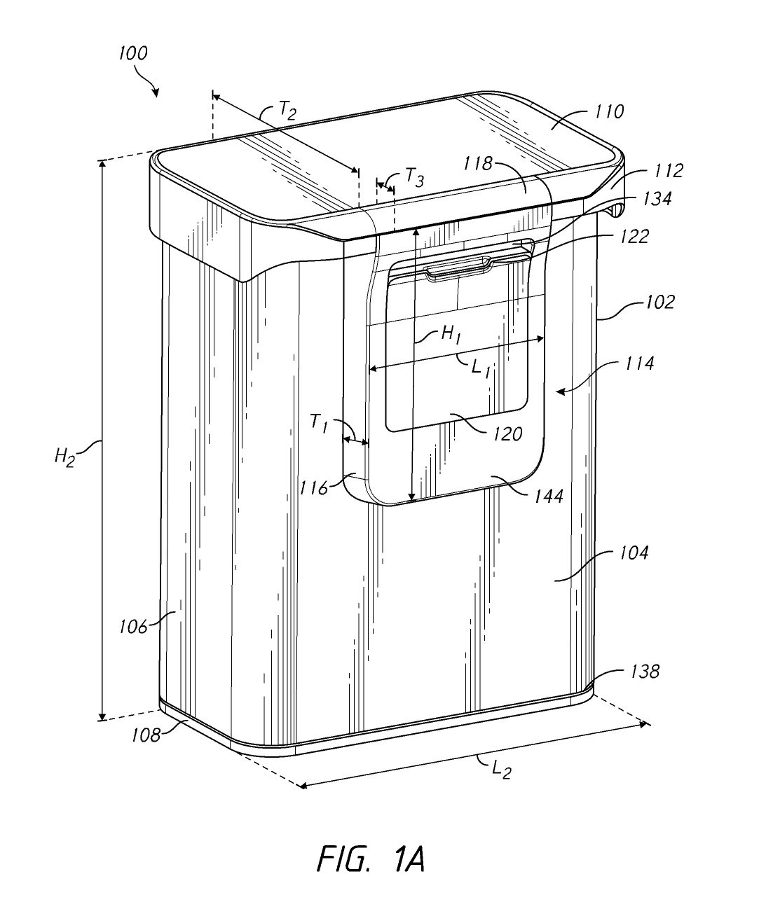

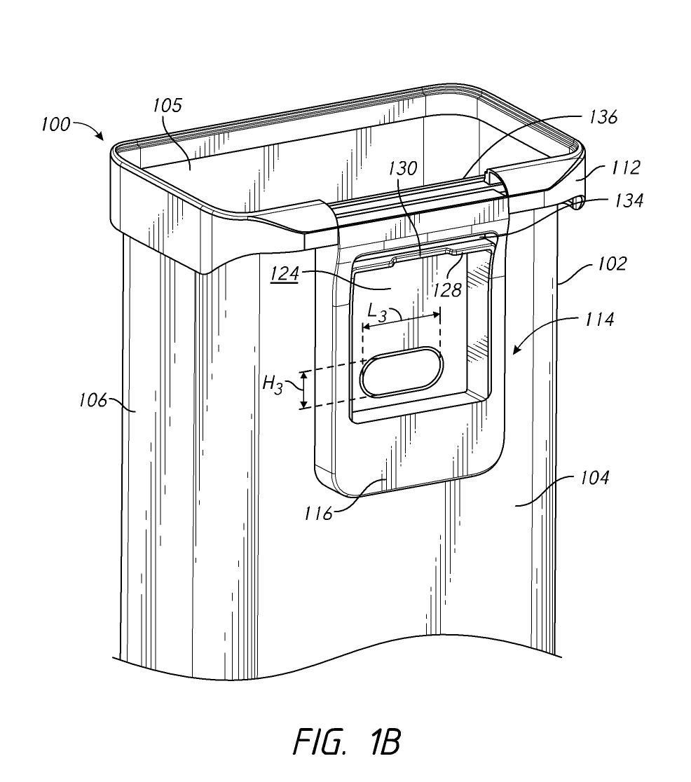

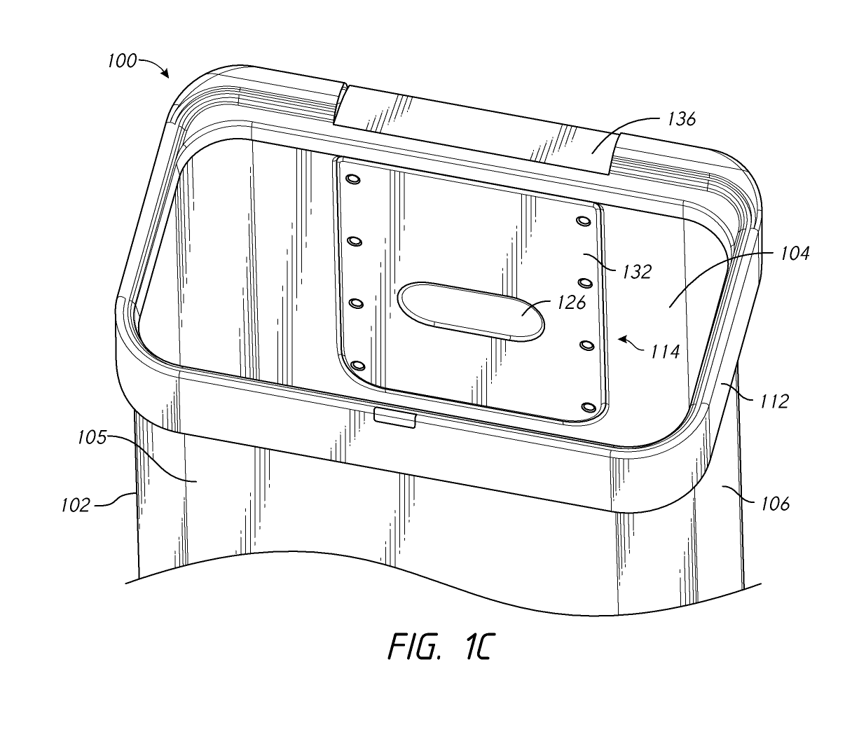

FIGS. 1A-1C illustrate a receptacle assembly 100 having a body portion 102, a base portion 108, and a lid portion 110 movable with respect to the body portion 102. The base portion 108 can support the receptacle assembly 100 in a stable, resting position when the receptacle assembly 100 rests on a surface such as a floor, and the body portion 102 can extend upward from the base portion 108. In some embodiments, the base portion 108 can be formed of a plastic material and/or can comprise a skirt or foundation that extends generally all of the way around the receptacle 100, from the ground to the bottom of the body portion 102. Although not shown, the receptacle assembly 100 can include a mechanism to move the lid portion 110 from a closed to an open position, such as a pedal-operated mechanism or a sensor-activated mechanism. Additional information regarding sensor-activated mechanisms can be found in U.S. Publication No. 2011/0220647, filed Mar. 4, 2011, titled “TRASH CAN WITH POWER OPERATED LID,” which is hereby incorporated by reference in its entirety. Any features, structure, or step disclosed and/or illustrated in the '674 application can be utilized in combination with or instead of any features, structure, or step disclosed and/or illustrated in this specification.

The body portion 102 can include a front wall 105, a rear wall 104, and lateral sidewalls 106 connecting the front wall 105 and the rear wall 104. If the lid portion 110 is pivotably connected (e.g., rotatably, hingedly, or otherwise) to the body portion 102, the rear wall 104 can be on the same side as the pivotable connection between the lid portion 110 and the body portion 102. The body portion 102 can comprise an upper edge 136 and a lower edge 138. The lid portion 110 can be disposed along or near the upper edge 136 of the body portion 102, and the base portion 108 can be disposed along or near the lower edge 138 of the body portion 102. Although FIGS. 1A-1C illustrate a generally rectangular body portion 102, the body portion 102 can be generally cylindrical or any other shape. Any of the receptacle assembly 100 components can be formed from one or more different materials, such as sheet metals (e.g., sheet stainless steel or aluminum), other metals, plastics, and/or other materials. For example, the body portion 102 can include a 23 to 26 gauge (i.e., a thickness between about 0.0179 inches and 0.0269 inches) stainless sheet shell.

In some embodiments, to help provide a generally open, generally unobstructed, generally even distribution of contents (e.g., waste) inside of the bag liner, an interior surface of the body portion 102 can have a generally smooth, generally continuous, and/or generally unobstructed surface that extends entirely or substantially entirely across the interior surface of the body portion 102 from the upper edge 136 of the body portion 102 to the lower edge 138 of the body portion 102 (see FIG. 1C). In some embodiments, the interior surface of the body portion 102 can be free of substantial bumps, protrusions, recesses, and/or other features that produce appreciable unevenness (e.g., greater than or equal to about 5 mm change in a dimension generally perpendicular to a plane parallel to the interior surface).

Various embodiments of the receptacle assembly 100 can include an upper trim member 112 coupled to the lid portion 106 (see FIGS. 1A-1C). The trim member 112 can comprise a plastic or metal edge, border region, or otherwise, generally positioned at or near a top portion of the receptacle assembly 100. The trim member 112 can be pivotably coupled (e.g., rotatably, hingedly, or otherwise) with the body portion 102. When the trim member 112 is in a closed position, the trim member 112 can engage the upper edge 136 of the body portion 102.

As discussed above, in some scenarios, bag liners may not be easily accessible, which may result in the receptacle assembly being without a bag liner for an extended period of time. During that time, waste may be thrown directly into the receptacle assembly, thus contaminating the receptacle assembly. Accordingly, it can be desirable to provide the receptacle assembly 100 with a bag liner dispenser 114, such that the bag liners are conveniently located and easily accessible. The bag liner dispenser 114 can be configured to receive and to dispense one or more bag liners (e.g., a package of bag liners), but the term “bag liner dispenser” does not require the presence of bag liners therein at all times. For example, the portion of a waste receptacle that can be configured to receive a package of bag liners can be considered a “bag liner dispenser” even before the product has ever received bag liners or ever been used to dispense bag liners.

FIGS. 1A-1C illustrate an embodiment of the bag liner dispenser 114. As shown, the dispenser 114 can be secured to the rear wall 104 of the body portion 102, such that multiple bag liners can be stored in the bag liner dispenser 114, disposed exterior to the rear wall 104 prior to use. In some variants, the dispenser 114 is positioned on the exterior of the front wall 105 or on one of the sidewalls 106. Such exterior configurations can maintain an interior volume of the receptacle assembly 100. Positioning the bag liner dispenser 114 on a front, side, or rear wall of the body portion 102 can avoid a reduction in a depth of the interior volume without increasing an overall height of the receptacle assembly 100. In some embodiments, positioning the bag liner dispenser 114 exterior to the rear wall 104 leaves the interior surface of the rear wall 104 generally smooth, generally planar (e.g., positioned generally vertically), generally continuous, and/or generally unobstructed (e.g., free of any substantial bumps, protrusions, recesses, and/or other discontinuous features). This can avoid a reduction of the interior volume of the body portion 102 and/or reduce the chance that a bag liner disposed within the receptacle assembly 100 will be torn by the bag liner dispenser 114. Additionally, positioning the bag liner dispenser 114 on a rear wall 114 of the receptacle assembly 100 keeps the bag liner dispenser 114 out of plain sight when the rear wall 104 is positioned against a wall (e.g., wall of a house, building, or other structure) and avoids creating an obstruction to people or pets walking past the receptacle assembly 100.

As illustrated, by providing the bag liner dispenser 114 in an exterior region of the trash can, and/or near the top of the trash can, such as between a middle vertical region and a top region of a wall of the trashcan (e.g., rather than inside the trash can and/or at or near the bottom of the trash can), the user can more easily access bag liners without having to severely stoop over and/or the user can replenish bag liners from the outside of the trash can, without being required to remove a bag liner inside the trash can or other receptacle that may be partially filled with trash in order to access and replenish the bag liner dispenser with additional bag liners.

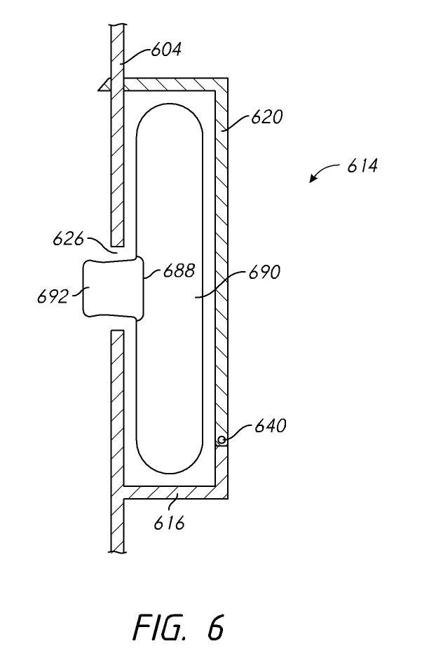

In some embodiments, as shown in FIG. 1C, the rear wall 104 can include an opening through which an interior wall 132 of the bag liner dispenser 114 can be inserted. In some embodiments, a portion (e.g., the inner wall 132) of the bag liner dispenser 114 can be coupled to an exterior surface of the rear wall 104. In certain embodiments, at least a portion of the bag liner dispenser 114 can be integrally formed with the body portion 102, such that a wall portion of the body portion 102 forms a part of the bag liner dispenser 114 (e.g., see FIG. 6).

In some embodiments, the bag liner dispenser 114 can generally include a housing 116 with an interior volume 124 in which one or more bag liners (not shown) can be disposed. The bag liner dispenser 114 can include a dispenser lid 120 removably or movably (e.g., rotatably, hingedly, or otherwise) connected to the housing 116. The dispenser lid 120 can include a user-grip portion 122 (e.g., groove, handle, or otherwise), such that the dispenser lid 120 can be easily moved between an open position and a closed position. In some embodiments, as shown in FIG. 1A, the housing 116 can have an opening 134 (e.g., channel, groove, indentation, or likewise) near the user-grip portion 122 so that the user can easily grasp the user-grip portion 112. Further, as shown in FIG. 1B, the housing 116 can include a support member 128 that can engage the dispenser lid 120 when the dispenser lid 120 is in the closed position. For example, the dispenser lid 120 can form a snap connection with a groove 130 of the support member 128.

In some embodiments, the housing 116 can include a rear cover 144. In some embodiments, the rear cover 144 is separately formed from a portion of the housing 116. FIG. 1B illustrates the bag liner dispenser 114 with the rear cover 144 removed. As shown in FIG. 1A, the rear cover 144 can extend from a lower edge of the bag liner dispenser 114 to an upper edge of the bag liner dispenser 114. The rear cover 144 can include an upper portion 118 that extends over the upper edge 136 of the body portion 102. For example, as shown in FIG. 1A, the upper portion 118 can wrap around at least a portion of the upper edge 136 (see FIG. 1B) of the body portion 102 (or the trim member 112, lid portion 110, or any other component at or near the upper edge 136 of the body portion 102). The upper portion 118 can be disposed between the ends of the trim member 112 and can be generally aligned (e.g., substantially flush) with a rear portion of the trim member 112.

As shown in FIGS. 1B and 1C, an opening 126 can be formed in the interior wall 132 of the bag liner dispenser 114 and/or the rear wall 104 of the body portion 102 (e.g., when the bag liner dispenser 114 is integrally formed with the body portion 102). The opening 126 can provide access from an interior volume 124 of the bag liner dispenser 114, through the rear wall 104, to an interior space of the body portion 102. As shown in FIG. 1B, the opening 126 can be generally oblong. A length L₃ of the opening 126 can be greater than a height H₃ of the opening 126, such as at least two times greater or at least three times greater than the height H₃ of the opening 126. In some embodiments, the area of the opening 126 is substantially less than the upper main opening into the interior space of the body portion 102 around which the upper edge 136 extends (e.g., less than or equal to about one-tenth of the area of the main opening).

The opening 126 provides the user with easy access to the bag liners. For example, when the bag liner dispenser 114 is positioned on the rear wall 104 of the body portion 102 and the rear wall 104 is positioned against a wall (e.g., a wall of a house, building, or other structure), a user can, from within the receptacle, extract a bag liner from the dispenser 114 via the opening 126. This can avoid the need to move the receptacle assembly 100, such as if the opening was disposed along a rear surface of the bag liner dispenser 114.

The bag liner dispenser 114 and the opening 126 can be positioned closer to the upper edge 136 of the body portion 102 than the lower edge 138 of the body portion 102. For example, the opening 126 can be formed in the upper half or upper quarter of the rear wall 104. This can put the bag liners in a convenient location. For example, in this configuration, the user can easily access a first bag of the plurality of bags and each subsequent bag without having to bend over and/or extend their arm too far into the receptacle assembly 100. In some embodiments that include an interior rigid waste container (not shown), the opening 126 can be located vertically above the level of the top of the waste container so as not to block the opening 126 by the inner waste container. In some embodiments, an opening in the inner waste container can permit access to the dispenser 114 through both the opening in the outer surface of the receptacle assembly 100 and the opening in the waste container.

In certain implementations, it can be desirable to minimize the overall size occupied by the receptacle assembly 100 during operation. For example, it can be desirable for the receptacle assembly 100 to be able to operate generally flush against a wall (e.g., the wall in a house). In some embodiments, as shown in FIGS. 1A and 1B, a rear surface of the bag liner dispenser 114 (e.g., the rear cover 144 and/or housing 116) does not extend in a rearward direction beyond a rear edge of the trim member 112 (or a rear edge of the lid portion 110 or other rear edge of an upper portion of the receptacle assembly 100). To provide a generally low-profile receptacle assembly 100, the length L₁ and/or the height H₁ of the bag liner dispenser 114 can be substantially greater than the thickness T₁ of the bag liner dispenser 114. For example, the thickness T₁ can be less than or equal to about 50% of the length L₁ of the bag liner dispenser 114, preferably less than or equal to about 25% of the length L₁ of the bag liner dispenser 114, such as less than or equal to about 15% of the length L₁ of the bag liner dispenser 114. As another example, the thickness T₁ can be less than or equal to about 50% of the height H₁ of the bag liner dispenser 114, preferably less than or equal to about 25% of the height H₁ of the bag liner dispenser 114, such as less than or equal to about 15% of the height H₁ of the bag liner dispenser 114, or less than or equal to about 10% of the height H₁ of the bag liner dispenser 114.

In some embodiments, a thickness T₁ of the bag liner dispenser 114 can be less than or equal to a thickness T₃ of the trim member 112 (see FIG. 1A). In some embodiments, the thickness T₁ of the bag liner dispenser 114 can be less than or equal to about one-half the thickness T₂ of the body portion 102, such as less than or equal to about one-third the thickness T₂ of the body portion 102, preferably less than or equal to about one-fifth the thickness T₂ of the body portion 102. In some embodiments, the length L₁ of the bag liner dispenser 114 can be less than or equal to about 75% of the length L₂ of the body portion 102, preferably less than or equal to about 50% the length L₂ of the body portion 102. In some embodiments, the height H₁ of the bag liner dispenser 114 can be less than or equal to about 75% of the height H₂ of the body portion 102, such as less than or equal to about 50% the height H₂ of the body portion 102, preferably less than or equal to about 40% the height H₂ of the body portion 102.

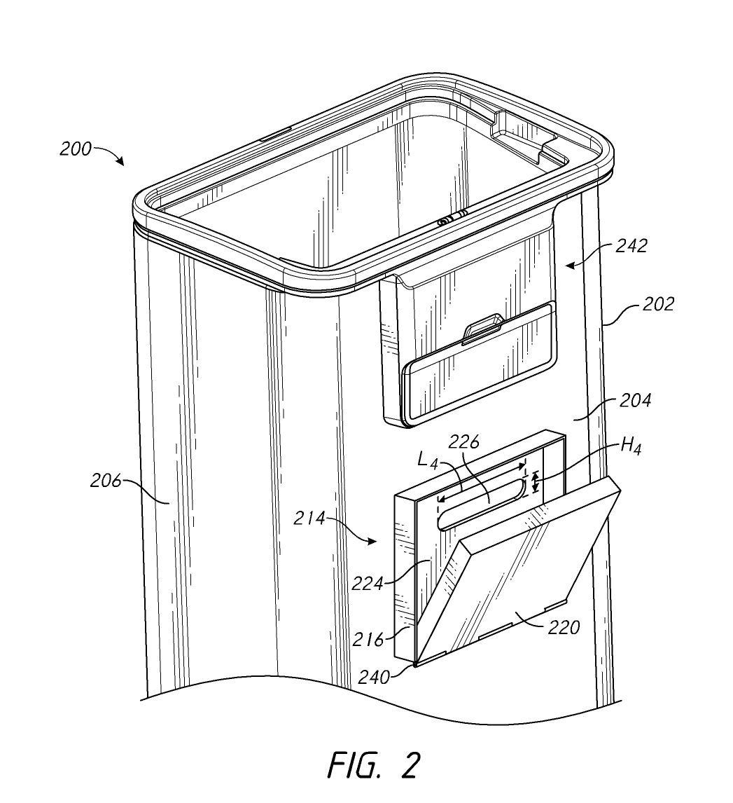

With reference to FIG. 2, another example of an embodiment of a receptacle assembly 200 having a bag liner dispenser 214 is shown. The bag liner dispenser 214 resembles or is identical to the bag liner dispenser 114 discussed above in many respects and can include any of the same desirable features or components as the bag liner dispenser 114. Accordingly, numerals used to identify features of the bag liner dispenser 114 are incremented by a factor of one hundred (100) to identify like features of the bag liner dispenser 214. This numbering convention generally applies to the remainder of the figures. Any structure, component, or step disclosed in any embodiment in this specification can be used in any other embodiments within the scope of this disclosure.

FIG. 2 illustrates a receptacle assembly 200 having a backside enclosure 242 that can house a power source for the receptacle assembly 200. The bag liner dispenser 214 can be positioned below the backside enclosure 242 on (e.g., secured to) the rear wall 204 of the receptacle assembly 200. The bag liner dispenser 214 can include dimensions that are the same as or similar to the bag liner dispenser 114. Further, the proportions between the bag liner dispenser 214 and the body portion 202 can be the same as or similar to the bag liner dispenser 114 and the body portion 102.

The bag liner dispenser 214 can include a housing 216 with an interior volume 224 in which one or more bag liners (not shown) can be disposed. Additionally, the bag liner dispenser 214 can include a dispenser lid 220 movably (e.g., rotatably, hingedly, or otherwise) connected to the housing 216. For example, as shown in FIG. 2, the dispenser lid 220 can rotate about a pivot member 240. In some embodiments, the dispenser lid 220 can be biased to a closed position, such as by a spring. When the dispenser lid 220 is in the closed position, the dispenser lid 220 can engage or interface with the housing 216.

As shown in FIG. 2, an opening 226 can be located in the rear wall 204 of the body portion 202. The opening 226 can provide access from an interior volume 224 of the bag liner dispenser 214 to an interior space of the body portion 202. In some embodiments, the opening 226 can be generally oblong. A length L₄ of the opening 226 can be greater than a height H₄ of the opening 226, such as at least two times greater or at least three times greater than the height H₄ of the opening 226. In certain variants, the length L₄ of the opening 226 is less than or equal to the height H₄ of the opening.

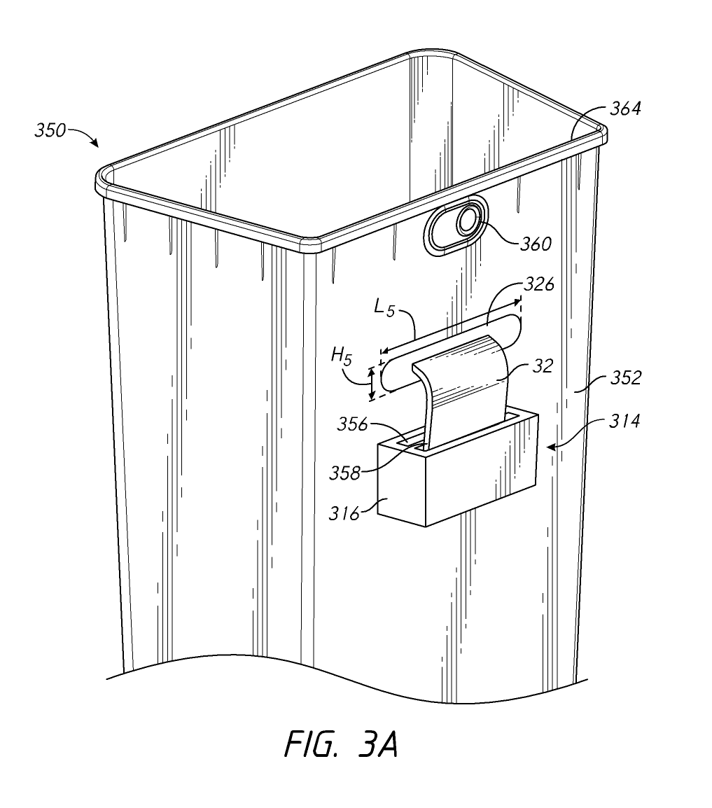

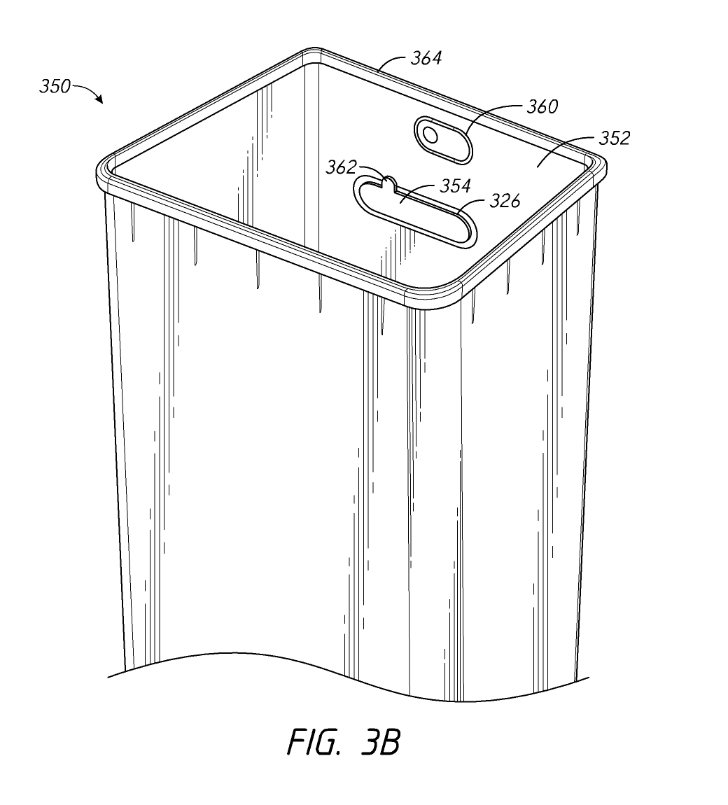

As mentioned above, some receptacles can include an interior metal or plastic liner that fits within the receptacle, which can be removed and washed. FIGS. 3A and 3B illustrate an illustrative interior container 350. As shown, the interior container 350 can have a bag-securing member 360. For example, a user can secure a bag liner in the bag-securing member 360 by pushing an upper portion of a bag liner into a portion of the bag-securing member 360 that can be configured to removably secure the bag, requiring greater force to remove the received portion of the bag from the bag-securing member 360 than would normally be exerted on the bag by the accumulation of waste therein.

In some embodiments, a bag liner dispenser 314 can be positioned between the interior container 350 and the body portion of a receptacle assembly (not shown) when the interior container 350 is positioned in the interior space of the body portion. For example, the bag liner dispenser 314 can be positioned on (e.g., secured to) the rear wall 352 of the interior container 350 (see FIG. 3A). In some embodiments, the dispenser 314 is positioned on an interior rear wall of the receptacle assembly and the interior container 350 has a recess configured to receive the dispenser 314 (not shown). The bag liner dispenser 314 can include dimensions similar to the bag liner dispenser 114. Further, the proportions between the bag liner dispenser 314 and the interior container 350 can be the same as or similar to the bag liner dispenser 114 and the body portion 102.

The bag liner dispenser 314 can include a housing 316 having an opening 356 for receiving a plurality of bag liners (not shown). The bag liner dispenser 314 can also include a biasing member 372 (e.g., a leaf spring, torsion spring, tension spring, compression spring, or otherwise). The biasing member 372 can be positioned in an opening 358 of the housing 316 or otherwise secured to the housing 316 (e.g., fixed to an outer surface of the housing 316). At least a portion of the plurality of bag liners can be positioned between the rear wall 352 of the interior container 350 and the biasing member 372. The biasing member 372 can be biased toward the rear wall 352 to maintain the position of the bag liners relative to the rear wall 352. In some embodiments, the biasing member 372 can be configured to bias packaging (e.g., a box) in which the bag liners are disposed.

As shown in FIG. 3A, an opening 326 can be positioned in the rear wall 352 of the interior container 350. The opening 326 can provide access from the bag liner dispenser 314 to an interior space of the interior container 350. In certain implementations, the opening 326 can be positioned closer to an upper edge 364 of the interior container 350 than a lower edge of the interior container 350. In some embodiments, the opening 326 can be generally oblong. A length L₅ of the opening 326 can be greater than a height H₅ of the opening 326, such as at least two times greater or at least three times greater than the height H₅ of the opening 326. FIG. 3B illustrates an interior view of the opening 326 with a tabbed portion 362 of the bag liner 354 extending through the opening 326. The tabbed portion 362 can be integrally formed with and include the same material as the remaining portion of the bag liner 354. The tabbed portion 362 of a bag liner 360 can be configured to extend outside of a package of one or more bag liners while the rest of the bag liner remains generally inside of the package. In certain variants, the tabbed portion 362 can be separately formed and attached to the remaining portion of the bag liner 354. The tabbed portion 362 can be configured to facilitate accessing a bag liner 354 from the bag liner dispenser 314. As with all features, structures, components, or steps disclosed in this specification, the tabbed portion 362 can be used with any embodiment in this specification.

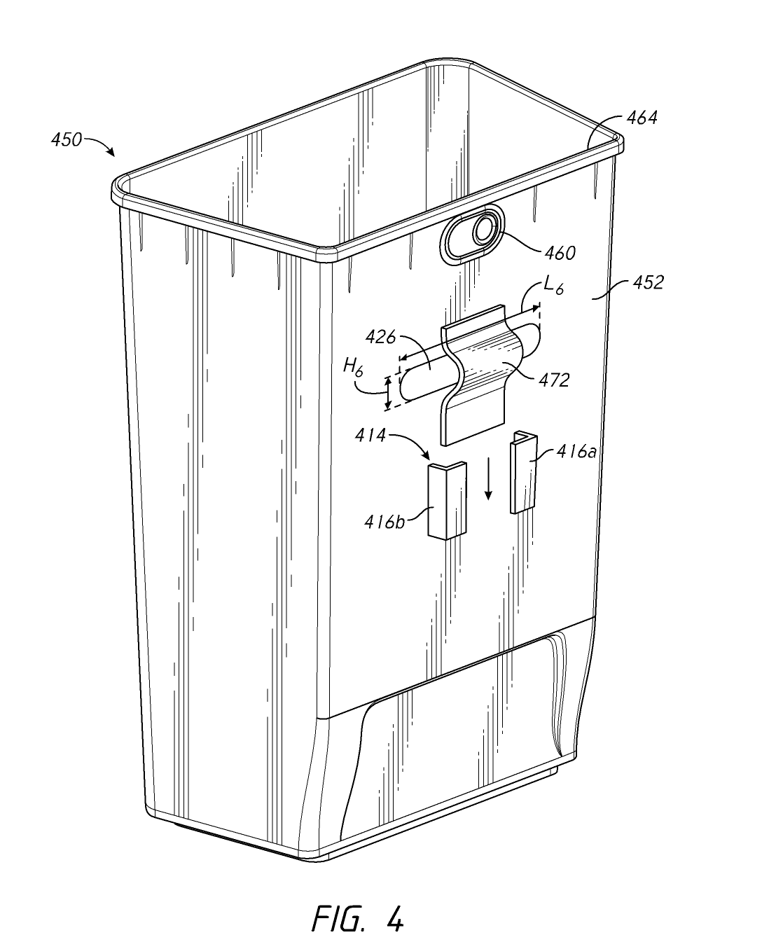

FIG. 4 illustrates another example of an interior container 450 having a bag-securing member 460. The bag liner dispenser 414 can be positioned below the bag securing member 460 and secured to the rear wall 452 of the interior container 460, such that the bag liner dispenser 414 is positioned between the interior container 460 and the body portion of a receptacle assembly when the interior container 460 is positioned in the interior space of the body portion. The bag liner dispenser 414 can include dimensions that are the same as or similar to the bag liner dispenser 114. Further, the proportions between the bag liner dispenser 414 and the interior container 450 can be the same as or similar to the bag liner dispenser 114 and the body portion 102.

Unlike the bag liner dispenser 314, the bag liner dispenser 414 can include spaced apart housing portions 416a, 416b in which a biasing member 472 (e.g., a leaf spring, torsion spring, tension spring, compression spring, or otherwise) can be positioned. For example, as shown, the biasing member 412 can be slidably received in the housing portions 416a, 416b. A plurality of bag liners can be positioned between the rear wall 452 and the biasing member 472 and/or within the housing portions 416a, 416b. The biasing member 472 can be biased toward the rear wall 452 to maintain the position of the bag liners relative to the rear wall 452. In some embodiments, the biasing member 472 can be configured to bias packaging (e.g., a box) in which the bag liners are disposed.

As shown in FIG. 4, an opening 426 can be formed in the rear wall 452 of the interior container 450. The opening 426 can provide access from the bag liner dispenser 414 to an interior space of the interior container 450. The opening 426 can be positioned closer to an upper edge 464 of the interior container 450 than a lower edge 466 of the interior container. In some embodiments, the opening 426 can be generally oblong. A length L₆ of the opening 426 can be greater than a height H₆ of the opening 426, such as at least two times greater or at least three times greater than the height H₆ of the opening 426.

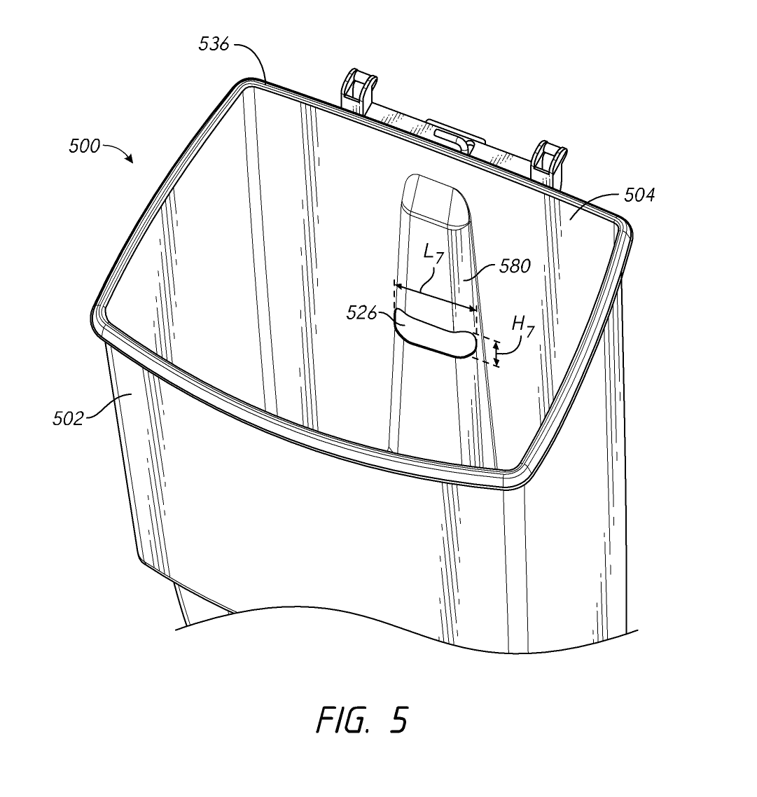

FIG. 5 illustrates an interior view of a receptacle assembly 500 that can be used with any of the dispenser assemblies described herein. The rear wall 504 of the receptacle assembly 500 can include an inward protrusion 580 extending into the interior space of the receptacle assembly 500. The inward protrusion 580 can form a recessed channel on an exterior surface of the receptacle assembly 500. In some embodiments, the dispenser assembly is attached to an outer surface of the inward protrusion 580, or the inward protrusion 580 generally encloses or constitutes the dispenser assembly (e.g., the dispenser assembly can be positioned in the recessed channel). An opening 526 can be positioned along the inward protrusion 580. The opening 526 can be closer to the upper edge 536 of the body portion 502 than a lower edge of the body portion 502. The opening 526 can provide access from the bag liner dispenser to an interior space of the receptacle assembly 500. In some embodiments, the opening 526 can be generally oblong. A length L₇ of the opening 526 can be greater than a height H₇ of the opening 526, such as at least two times greater or at least three times greater than the height H₇ of the opening 526.

FIG. 6 illustrates an embodiment of a bag liner dispenser 614 that can be used in connection with any of the receptacle assemblies and/or interior containers discussed herein. Similar to the bag liner dispenser 214, the bag liner dispenser 614 can include a housing 616 with an interior volume in which a package 690 of bag liners 692 can be disposed. The bag liner dispenser 614 can include a dispenser lid 620 movably (e.g., rotatably, hingedly, or otherwise) connected to the housing 616. For example, as shown in FIG. 6, the dispenser lid 620 can rotate about a pivot member 640. In some embodiments, the dispenser lid 620 can be biased to a closed position. When the dispenser lid 620 is in the closed position, the dispenser lid 620 can engage or interface with the rear wall 604 of the body portion.

A plurality of bag liners 692 can be folded, stacked, and/or rolled into the packaging 690. The plurality of bag liners 692 can be detached from each other, or the plurality of bag liners 692 can be connected in series and torn apart (e.g., along a perforation line between each of bag liners). As shown in FIG. 6, the packaging 690 can include an opening 688 through which a single bag liner 692 can be pulled. The opening 688 of the packaging 690 can be generally shaped, sized, and positioned such that the opening 688 generally aligns with the receptacle assembly opening 626. Similar to the bag liner 354, each of the bag liners 692 can include a tabbed portion to facilitate removal of each bag liner 692 from the packaging 690. In some embodiments, the last bag of the plurality of bags can include an indicator to signal that the package 690 of bag liners 692 should be replaced. For example, the last bag can be colored, include a message, or otherwise indicate that the bag liners 692 should be replaced. In some embodiments, an opening in a package of bag liners can be positioned to generally face and/or generally align with a corresponding opening in the body of a receptacle assembly and/or in the interior container.

In some methods of providing bag liners, a supplier may provide a package of multiple bag liners to a user of a waste receptacle, along with instructions to the user to insert the package of multiple bag liners into a bag liner dispenser on a wall (interior or exterior) of the waste receptacle such that an opening in the package can be oriented to generally align with the liner-access opening in the wall of the waste receptacle and/or to generally align with a liner-access opening in a wall of an interior container of the waste receptacle, to facilitate access to the bags liners within the package from inside of the waste receptacle.

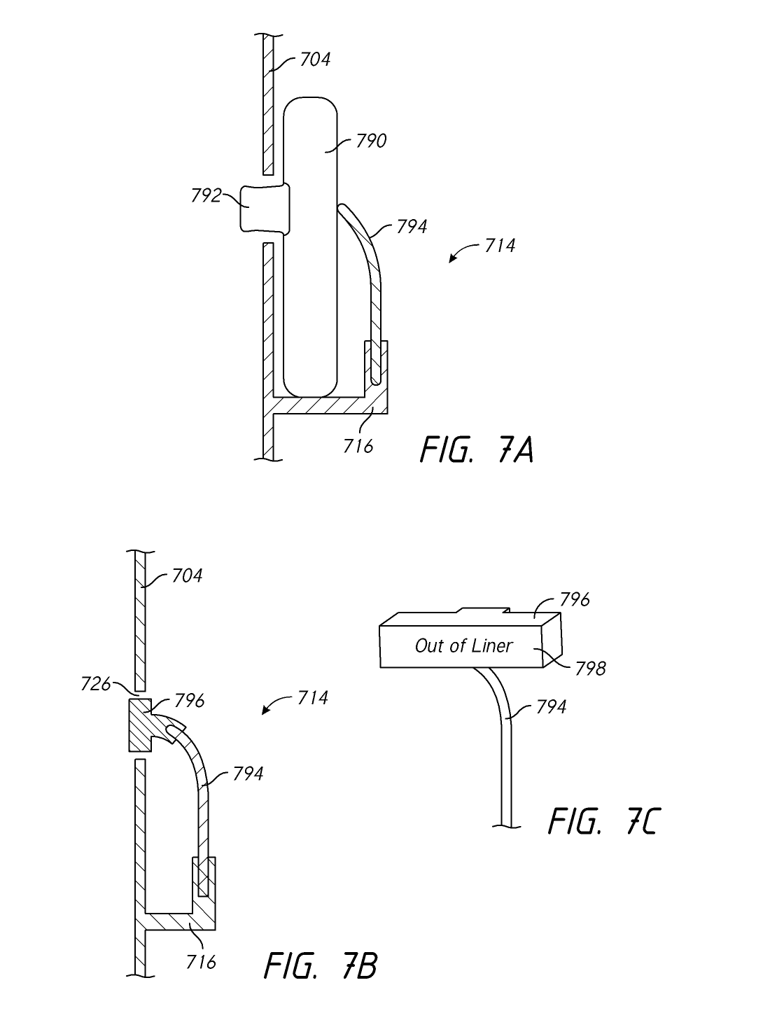

FIGS. 7A-7C illustrate another example of an embodiment of a bag liner dispenser 714 that can be used in connection with any of the receptacle assemblies and/or interior containers discussed herein. The bag liner dispenser 714 can include a housing 716 with an interior volume in which a package 790 of bag liners 792 can be disposed. The bag liner dispenser 714 can include a biasing member 794 (e.g., a leaf spring, torsion spring, tension spring, compression spring, or otherwise) secured to the housing 716. A package 790 of bag liners 792 can be positioned between the rear wall 704 of the receptacle assembly and the biasing member 794 and/or within the housing portion 716. The biasing member 794 can be biased toward the rear wall 704 to maintain the position of the bag liners 792 relative to the rear wall 704. For example, the biasing member 794 can encourage the bag liners to move generally toward the rear wall 704.

In some embodiments, as shown in FIGS. 7B and 7C, the biasing member 794 can include an end portion 796. The end portion 762 can be generally sized to fit within the opening 726 of the rear wall 704. A front face 798 of the end portion 796 can include a message, such as “out of liner,” or other indicator to indicate when the package 790 of bag liners 792 should be replaced. The package 790 of bag liners 792 can include any of the features of the package 690 of bag liners 692.

Although certain embodiments of the bag liner dispenser have been described herein with respect to certain receptacle assemblies or interior containers, the bag liner dispensers described herein can be used with any of the receptacles or interior containers described herein.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments.

The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

The terms “about” and “substantially” as used herein represent an amount close to the stated amount that still performs a desired function or achieves a desired result. For example, in some but not all embodiments, as the context may permit, the terms “about” and “substantially” may refer to an amount that is within 10% of the stated amount.

The term “generally” as used herein represents a value, amount, or characteristic that predominantly includes or tends toward a particular value, amount, or characteristic. As an example, in certain embodiments, as the context may permit, the term “generally perpendicular” can refer to something that departs from exactly perpendicular by less than or equal to 20 degrees.

The ranges disclosed herein also encompass any and all overlap, sub-ranges, and combinations thereof. Language such as “up to,” “at least,” “greater than,” “less than,” “between” and the like includes the number recited. Numbers preceded by a term such as “about” or “approximately” include the recited numbers. For example, “about 5 mm” includes “5 mm.”

For expository purposes, the term “horizontal” as used herein is defined as a plane parallel to the plane or surface of the floor of the area in which the receptacle assembly or interior container being described is used or the method being described is performed, regardless of its orientation. The term “floor” can be interchanged with the term “ground.” The term “vertical” refers to a direction perpendicular to the horizontal as just defined. Terms such as “above,” “below,” “bottom,” “top,” “side,” “higher,” “lower,” “upper,” “over,” and “under,” are defined with respect to the horizontal plane.

As used herein, the relative terms “front” and “rear” shall be defined from the perspective of the user opening the receptacle assembly when there is a lid portion. Thus, front refers to the direction of the receptacle closest to the user (e.g., the direction of the pedal or sensor), and rear refers to the direction of the receptacle furthest from the user (e.g., the direction of the connection between the lid portion and the body portion).

Although certain embodiments and examples have been described herein, it will be understood by those skilled in the art that many aspects of the receptacles and bag liner dispensers shown and described in the present disclosure may be differently combined and/or modified to form still further embodiments or acceptable examples. All such modifications and variations are intended to be included herein within the scope of this disclosure. A wide variety of designs and approaches are contemplated. No feature, structure, or step disclosed herein is essential or indispensable.

For purposes of this disclosure, certain aspects, advantages, and novel features are described herein. It is to be understood that not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Moreover, while illustrative embodiments have been described herein, the scope of any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to the examples described in the present specification or during the prosecution of the application, which examples are to be construed as non-exclusive. Further, the actions of the disclosed processes and methods may be modified in any manner, including by reordering actions and/or inserting additional actions and/or deleting actions. It is intended, therefore, that the specification and examples be considered as illustrative only, with a true scope and spirit being indicated by the claims and their full scope of equivalents.

The following is claimed:

1. A receptacle assembly comprising:
a body portion comprising a front wall, a rear wall, and lateral side walls connecting the front wall and the rear wall, the body portion further comprising an upper edge and a lower edge;
an opening disposed on the rear wall of the body portion; and
a bag liner dispenser positioned near the opening and disposed on an exterior surface of the rear wall, wherein the opening provides access from the bag liner dispenser to an interior space of the body portion.

2. The combination of the receptacle assembly of claim 1 and one or more bag liners.

3. The receptacle assembly of claim 1, wherein the bag liner dispenser is disposed closer to the upper edge of the body portion than the lower edge of the body portion.

4. The receptacle assembly of claim 1, wherein a lower edge of the bag liner dispenser is displaced from the lower edge of the body portion.

5. The receptacle assembly of claim 1, wherein the bag liner dispenser further comprises a dispenser lid.

6. The receptacle assembly of claim 1, further comprising a trim member extending at least partially around the upper edge of the body portion, wherein a thickness of the bag liner dispenser is less than or equal a thickness of a rear portion of the trim member.

7. The receptacle assembly of claim 1, wherein an interior surface of the rear wall is generally planar.

8. The receptacle assembly of claim 1, wherein the opening is generally flush with the rear wall.

9. The receptacle assembly of claim 1, wherein a length of the opening is greater than a height of the opening.

10. The receptacle assembly of claim 1, wherein the opening is displaced from the upper edge of the body portion.

11. The receptacle assembly of claim 1, further comprising an inner body portion disposed within the interior space of the body portion, the inner body portion having an opening that provides access from the bag liner dispenser to an interior space of the inner body portion.

12. The receptacle of claim 1, further comprising a lid portion movably engaged with the body portion, the lid portion connected to the rear wall of the body portion.

13. A method of manufacturing a receptacle assembly comprising:
providing an opening on a rear wall of a body portion, the body portion defining an interior space; and
positioning a bag liner dispenser along an exterior surface of the rear wall and near a periphery of the opening, such that the opening provides access from the bag liner dispenser to the interior space of the body portion.

14. The method of claim 13, further comprising disposing the bag liner dispenser closer to an upper end of the body portion than a lower end of the body portion.

15. The method of claim 13, further comprising connecting a dispenser lid to the bag liner dispenser.

16. The method of claim 13, disposing a trim member at least partially around an upper edge of the body portion, wherein a thickness of the bag liner dispenser is less than or equal a thickness of a rear portion of the trim member.

17. The method of claim 13, wherein an interior surface of the rear wall is generally planar.

18. The method of claim 13, wherein forming the opening comprises forming the opening generally flush with the rear wall.

19. The method of claim 13, wherein forming the opening comprises forming the opening with a length that is greater than a height of the opening.

20. The method of claim 13, wherein forming the opening comprises positioning the opening at a location displaced from an upper edge of the rear wall.

21. The method of claim 13, further comprising inserting an inner body portion into the interior space of the body portion, the inner body portion having an opening that provides access from the bag liner dispenser to an interior space of the inner body portion.

22. The receptacle of claim 13, further comprising connecting a lid portion to the rear wall of the body portion.

23. A method of inserting a liner into a receptacle, the method comprising:
inserting a plurality of bag liners into a bag liner dispenser disposed on an exterior surface of a rear wall of a receptacle, the bag liner dispenser extending around a periphery of an opening disposed on the rear wall of the receptacle; and
pulling a first bag of the plurality of bags through an opening disposed on the rear wall of the body portion into an interior of the receptacle.
